(19) United States
(12) Patent Application Publication
(10) Pub. No.: US 2022/0411595 A1
(43) Pub. Date: Dec. 29, 2022

(54) Biodegradable Compositions and Products Produced Therefrom

(71) Applicant: TIPA CORP. LTD, Hod HaSharon (IL)

(72) Inventors: Eli Lancry, Gan Yavne (IL); Neta Atias Mekahel, Rehovot (IL); Yaniv David, Tzur Yitzhak (IL)

(21) Appl. No.: 17/781,580

(22) PCT Filed: Nov. 18, 2020
(86) PCT No.: PCT/IL2020/051194

§ 371 Date: Jun. 1, 2022

Related U.S. Application Data
(60) Provisional application No. 62/942,139, filed on Dec. 1, 2019.

(51) Int. Cl. C08J 5/18; C08L 67/03; C08L 67/02; C08L 67/04; A47G 21/18

(52) U.S. Cl. CPC C08J 5/18; C08L 67/03; C08L 67/02; C08L 67/04; A47G 21/18; C08J 2367/03; C08J 2367/02; C08J 2367/04; C08L 2201/06; C08L 2203/18; C08L 2205/035; C08L 2205/02

(57) ABSTRACT

The present invention is directed to biodegradable sheets and straws formed from a composition comprising a first biodegradable polymer selected from the group consisting of PBAT, PBS, PLA and combinations thereof; and a second biodegradable polymer selected from the group consisting of PBS, PLA, PCL, PBSA, PBAT and combinations thereof, wherein the first biodegradable polymer is different from the second biodegradable polymer and wherein the straws or sheets have a thickness of 100-250 microns.

### CROSS-REFERENCE TO RELATED APPLICATIONS

The present application claims the benefit of U.S. Provisional Application Ser. No. 62/942,139 filed 1 Dec. 2019, which is included by reference as if fully set-forth herein.

### FIELD OF THE INVENTION

The present invention, in at least some embodiments, is directed to biodegradable compositions, and in particular to biodegradable sheets and straws formed from a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof.

### BACKGROUND OF THE INVENTION

The use of biodegradable materials had increased over the past years due to the environmentally beneficial properties of such materials. Such materials are now commonly used in the manufacture of a wide range of products, including various types of plastic bags and other forms of packaging.

Examples of such polymers include polyesteramide (PEA), modified polyethylene terephthalate (PET). biopolymers based on polylactic acid (PLA), polyhydroxyalkanoates (PHA), which include polyhydroxybutyrate (PHB), polyhydroxyvalerate (PHV) and polyhydroxybutyrate-hydroxyvalerate copolymer (PHBV), and poly (epsilon-caprolactone) (PCL).

Each of the foregoing biopolymers has unique properties, benefits and weaknesses. For example, modified PET, PEA, PHB and PLA tend to be strong but are also quite rigid or even brittle. This makes them poor candidates when flexible sheets are desired, such as for use in making wraps, bags and other packaging materials requiring good bend and folding capability.

On the other hand, biopolymers such as PHBV and polybutylene adipate terphtalate (PBAT) are many times more flexible than the biopolymers discussed above, but have relatively low melting points so that they tend to be self-adhering and unstable when newly processed and/or exposed to heat.

Further, due to the limited number of biodegradable polymers, it is often difficult, or even impossible, to identify a single polymer or copolymer that meets all, or even most, of the desired performance criteria for a given application.

Disposable drinking straws manufactured from plastics are widely known and commercially available. The widespread use of plastic drinking straws has become an increasing source of concern due to the environmental issues associated with their disposal. Increasingly large numbers of such straws litter and pollute both land and waterways, causing harm to marine and land animals, as well as clogging landfills.

There remains a need for biodegradable sheets and straws having a required degree of stiffness to enable extrusion as a self-supporting structure, which are preferably also home compostable.

### SUMMARY OF THE INVENTION

The present invention relates to biodegradable sheets and straws formed from a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof.

According to an aspect of some embodiments of the present invention, there is provided a biodegradable drinking straw comprising an elongated wall enclosing a lumen, wherein said wall is a monolayer comprising a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof,
wherein said first biodegradable polymer is present at a concentration of greater than 50% w/w of the total composition and
wherein said first biodegradable polymer is different from said second biodegradable polymer,
said monolayer having a thickness of from about 100 to about 250 microns.

According to an aspect of some embodiments of the present invention, there is provided a method of producing a biodegradable drinking straw as disclosed herein, the method comprising:
i) Discharging said composition through an extrusion die to provide an extrudate;
ii) Substantially immediately following said discharging, cooling said extrudate; and
iii) Cutting said extrudate into a desired length.

According to an aspect of some embodiments of the present invention, there is provided a biodegradable monolayer sheet comprising a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof,
wherein said first biodegradable polymer is present at a concentration of greater than 50% w/w of the total composition and
wherein said first biodegradable polymer is different from said second biodegradable polymer,
said monolayer having a thickness of from about 100 to about 250 microns.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 schematically illustrates a biodegradable drinking straw in accordance with the principles of the present invention,

FIG. 2 schematically illustrates the biodegradable drinking straw of FIG. 1, further comprising a bendable region;

FIG. 3A schematically illustrates the biodegradable drinking straw of FIG. 1 comprising at least one colored and one uncolored stripe; and

FIG. 3B schematically illustrates the biodegradable drinking straw of FIG. 1 comprising at least two differently colored stripes.

### DETAILED DESCRIPTION OF THE INVENTION

### Definitions

Unless otherwise defined, all technical and scientific terms used herein have the same meaning as commonly understood by one of ordinary skill in the art to which the invention pertains. In case of conflict, the specification, including definitions, takes precedence.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It is to be noted that, as used herein, the singular forms “a”, “an” and “the” include plural forms unless the content clearly dictates otherwise. Where aspects or embodiments are described in terms of Markush groups or other grouping of alternatives, those skilled in the art will recognize that the invention is also thereby described in terms of any individual member or subgroup of members of the group.

As used herein, when a numerical value is preceded by the term “about”, the term “about” is intended to indicate +/−10%.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

The biodegradable compositions according to the invention can be used to manufacture a wide variety of articles of manufacture, including articles useful for containing therein, semi-solid or liquid substances, including ingestible substances such as food substances, drinks and medicines.

The term “biodegradable” as used herein is to be understood to include a polymer, polymer mixture, or polymer-containing sheet that degrades through the action of living organisms in air, water or any combinations thereof within 1 year. Biodegradable polyester degradation is initially by hydrolysis, to eventually break the polymer into short oligomers, and later by microbial degradation, or microbial digestion. Biodegradable material may break down under a variety of conditions, for example under aerobic or anaerobic conditions, in compost, in soil or in water (such as sea, rivers or other waterways).

Material which may be degraded in compost is referred to as compostable. Hence, as used herein, the term “compostable” refers to a polymer, polymer mixture, or polymer-containing sheet which is degraded by biological processes under aerobic conditions to yield carbon dioxide, water, inorganic compounds and biomass and leaves no visible, distinguishable or toxic residues. Composting of such materials may require a commercial composting facility or the material may be home compostable.

As used herein, the term “home compostable” refers to a polymer, polymer mixture, or polymer-containing sheet which is compostable in a home composting container, i.e. at significantly lower temperatures and in the absence of set conditions as compared to those provided in a commercial composting facility, Home composting is usually carried out in significantly smaller volumes than those used for commercial composting, and do not include an industrial shredding process.

The term “sheet” as used herein is to be understood as having its customary meanings as used in the thermoplastic and packaging arts and includes the term “film”. Such sheets may have any suitable thickness, may be of a single polymer layer or of multiple polymer layers. Such sheets may be manufactured using any suitable method including blown film extrusion and cast film extrusion.

As known to a person having ordinary skill in the art, some of the polymers discussed herein have one or more names or spelling thereof. For example, poly(epsilon-caprolactone), poly(caprolactone) and polycaprolactone are synonymous and the three terms are used interchangeably. Similarly, polylactic acid and poly(lactic acid) are synonymous.

The present invention relates to biodegradable sheets and straws formed from a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof.

The sheets and straws as disclosed herein are of a thickness which is sufficient to provide a required degree of stiffness for the purpose for which the straw or sheet is to be used, and to enable extrusion as a self-supporting structure. Since the ability of a sheet to be home compostable is a function of the sheet thickness, the sheets and straws disclosed herein are provided with a thickness which enables them to be home compostable.

According to an aspect of some embodiments of the present invention, there is provided a biodegradable drinking straw comprising an elongated wall enclosing a lumen, wherein said wall is a monolayer comprising a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof,
wherein said first biodegradable polymer is present at a concentration of greater than 50% w/w of the total composition and
wherein said first biodegradable polymer is different from said second biodegradable polymer,
said monolayer having a thickness of from about 100 to about 250 microns.

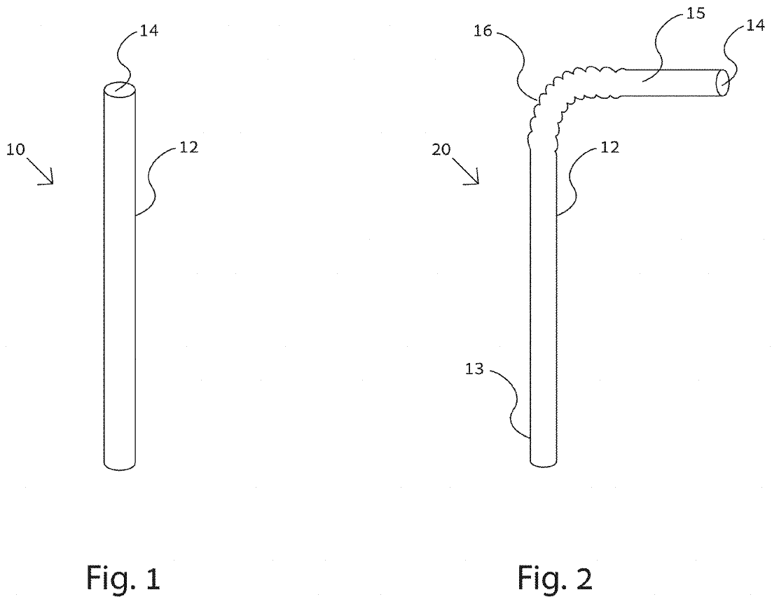

Referring now to FIG. 1, there is shown an exemplary biodegradable drinking straw 10 in accordance with the principles of the present invention. Drinking straw 10 comprises an elongated wall 12 enclosing a lumen 14, wherein elongated wall 12 comprises a monolayer having thickness of from about 100 to about 250 microns and wherein elongated wall 12 comprises a first and second polymer as disclosed herein.

According to some embodiments, said elongated wall comprises a first end and a second end, and a bendable region between the first end and the second end of the straw. In some such embodiments, the bendable region comprises a corrugated structure.

FIG. 2 schematically illustrates an exemplary biodegradable drinking straw 20 comprising an elongated wall 12 enclosing a lumen 14, wherein elongated wall 12 comprises a monolayer having thickness of from about 100 to about 250 microns and wherein elongated wall 12 comprises a first and second polymer as disclosed herein. Straw 20 comprises a first end 13 and a second end 15 and a bendable region between first end 13 and second end 15.

According to some embodiments, the monolayer has a thickness of about 100, about 110, about 120, about 130, about 140, about 150, about 160, about 170, about 180, about 190, about 200, about 210, about 220, about 230, about 240 or about 250 microns.

According to some embodiments, the first biodegradable polymer and the second biodegradable polymer together comprise at least 90% w/w of the total composition.

According to some embodiments of the biodegradable drinking straw, said first biodegradable polymer comprises PBAT.

According to some embodiments, said second biodegradable polymer comprises PBS.

According to some such embodiments, said PBAT is present in said composition at a concentration of from greater than 50% to 55% w/w (such as at least 51%, at least 52%, at least 53%, at least 54% or 55%) of the total composition and wherein said PBS is present in said composition at a concentration of from about 45% to less than 50% w/w (such as less than 45%, less than 46%, less than 47%, less than 48%, or less than 49%) of the total composition.

According to some embodiments, said second biodegradable polymer comprises PLA. According to some such embodiments, said PBAT is present in said composition at a concentration of from 55% to about 70% w/w (such as at least 55%, at least 57%, at least 60%, at least 65%, at least 67%, or about 70%) of the total composition, and wherein said PLA is present in said composition at a concentration of from about 30% to about 45% w/w (such as about 30%, about 33%, about 40%, about 43% or less than 45%) of the total composition.

According to some embodiments, said first biodegradable polymer comprises PBS.

According to some embodiments, said second biodegradable polymer comprises PLA. According to some such embodiments, said PBS is present in said composition at a concentration of from about 75% to about 80% w/w (such as about 75%, about 76%, about 77%, about 78%, about 79% or about 80%) of the total composition, and wherein said PLA is present in said composition at a concentration of from about 20% to about 25% w/w (such as about 20%, about 21%, about 22%, about 23%, about 24% or about 25%) of the total composition.

According to some embodiments, said first biodegradable polymer comprises PLA.

According to some embodiments, said second biodegradable polymer comprises PCL. According to some such embodiments, said PLA is present in said composition at a concentration of from about 70% to about 85% w/w (such as about 70%, about 71%, about 72%, about 73%, about 74%, about 75%, about 76%, about 77%, about 78%, about 79%, about 80%, about 81%, about 82%, about 83%, about 84% or about 85%) of the total composition and said PCL is present in said composition at a concentration of from about 15 to about 30% w/w (such as about 15%, about 16%, about 17%, about 18%, about 19%, about 20%, about 21%, about 22%, about 23%, about 24%, about 25%, about 26%, about 27%, about 28%, about 29% or about 30%) of the total composition.

According to some embodiments, said composition further comprises a third biodegradable polymer.

According to some embodiments, the first biodegradable polymer, the second biodegradable polymer and the third biodegradable composition together comprise at least 90% w/w of the total composition.

According to some embodiments, said third biodegradable polymer comprises PBSA. According to some such embodiments, said PLA is present in said composition at a concentration of from about 60% to about 70% w/w (such as about 60%, about 61%, about 62%, about 63%, about 64%, about 65%, about 66%, about 67%, about 68%, about 69% or about 70%) of the total composition, said PCL is present in said composition at a concentration of from about 15% to about 20% w/w (such as about 15%, about 16%, about 17%, about 18%, about 19% or about 20%) of the total composition and said PBSA is present in said composition at a concentration of from about 15% to about 20% w/w (such as about 15%, about 16%, about 17%, about 18%, about 19% or about 20%) of the total composition.

According to some embodiments, said third biodegradable polymer comprises PBAT. According to some such embodiments, said PLA is present in said composition at a concentration of from about 70% to about 85% w/w (such as about 70%, about 71%, about 72%, about 73%, about 74%, about 75%, about 76%, about 77%, about 78i %, about 79%, about 80%, about 81%, about 82%, about 83%, about 84% or about 85%) of the total composition, said PCL is present in said composition at a concentration of from about 10% to about 15% w/w such as about 15%, about 16%, about 17%, about 18%, about 19% or about 20%) of the total composition and said PBAT is present in said composition at a concentration of from about 5% to about 15% w/w (such as about 5%, about 6%, about 7%, about 8%, about 9%, about 10%, about 11%, about 12%, about 13%, about 14% or about 15%) of the total composition.

According to some embodiments, a first portion of said monolayer comprises a composition comprising PLA at a concentration of from about 70% to about 85% (such as about 70%, about 75%, about 80% or about 85%) w/w of the total composition and PCL at a concentration of from about 15% to about 30% (such as about 15%, about 20%, about 25% or about 30%) w/w of the total composition, wherein a second portion of said monolayer consists essentially of 100% PBAT. According to some such embodiments, the composition comprising PLA and PCL is extruded through an outlet of a main extruder, and the composition consisting essentially of 100% PBAT is extruded through an outlet of a satellite extruder, such that both compositions are introduced into a single feedblock.

According to some embodiments, a first portion of said monolayer comprises a composition comprising PLA at a concentration of from about 70 to about 85% w/w of the total composition and PCL at a concentration of from about 15 to about 30% w/w of the total composition, wherein a second portion of said monolayer consists essentially of 100% PBSA. According to some such embodiments, the composition comprising PLA and PCL is extruded through an outlet of a main extruder, and the composition consisting essentially of 100% PBSA is extruded through an outlet of a satellite extruder, such that both compositions are introduced into a single feedblock.

According to some embodiments, said composition further comprises a nucleating agent. As used herein, the term “nucleating agent” refers to a material which helps to control crystallization of the product. Non-limiting examples of suitable nucleating agents include poly-L-lactide (PLLA) homopolymers such as L130 from Cobion-Purac.

According to some embodiments, said composition further comprises at least one selected from the group consisting of an antioxidant, a slip agent, an antiblock, and combinations thereof.

Non-limiting examples of suitable antioxidants include ascorbic acid.

Non-limiting examples of suitable slip agents include erucamide.

Non-limiting examples of antiblock include silica.

According to some embodiments, said composition further comprises at least one coloring agent.

According to some embodiments, at least a first portion of said monolayer comprises a first coloring agent.

In some such embodiments, a second portion of said monolayer comprises a second coloring agent, wherein said second coloring agent provides a different color to that of said first coloring agent.

Alternatively, in some such embodiments, a second portion of said monolayer is devoid of a coloring agent. In some such embodiments, the second portion of the monolayer is substantially transparent.

In some embodiments wherein a first portion and a second portion of the monolayer do not comprise the same coloring agent (e.g. when a first portion comprises a coloring agent and the second portion is devoid of a coloring agent, or when a first portion and a second portion comprise different coloring agents), the monolayer is provided by extrusion of the first portion through an outlet of a main extruder and a second portion through an outlet of a satellite extruder, such that both portions are introduced into the same feedblock. The monolayer is thus formed having a traverse cross-section in which adjacent regions are of different color (in embodiments wherein two different coloring agents are used) such that colored stripes are provided; or of alternating colored/transparent regions (in embodiments wherein one portion is devoid of a coloring agent), such that the straw is formed having colored and transparent stripes.

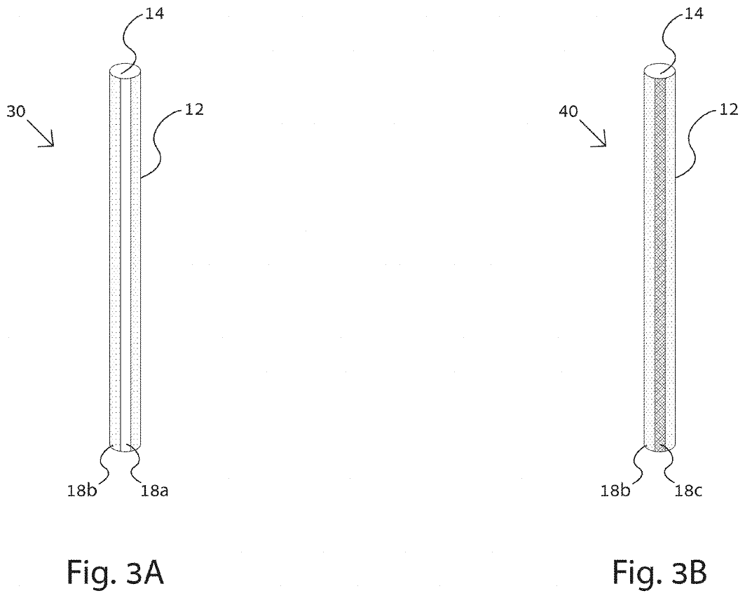

FIG. 3A schematically illustrates an exemplary biodegradable drinking straw 30 comprising an elongated wall 12 enclosing a lumen 14, wherein elongated wall 12 comprises a monolayer having thickness of from about 100 to about 250 microns and wherein elongated wall 12 comprises a first and second polymer as disclosed herein. A first portion of the monolayer of straw 40 is devoid of a coloring agent and a second portion of the monolayer comprises a coloring agent, such that elongated wall 12 comprises at least one uncolored (in some embodiments, transparent) stripe 18a and at least one stripe having a first color 18b.

FIG. 3B schematically illustrates an exemplary biodegradable drinking straw 40 comprising an elongated wall 12 enclosing a lumen 14, wherein elongated wall 12 comprises a monolayer having thickness of from about 100 to about 250 microns and wherein elongated wall 12 comprises a first and second polymer as disclosed herein. A first portion of the monolayer of straw 40 comprises a first coloring agent and a second portion of the monolayer comprises a second coloring agent, such that elongated wall 12 comprises at least one stripe having a first color 18b and at least one stripe having a second color 18c.

According to some embodiments, said elongated wall has a circular transverse cross-section.

According to some embodiments, said elongated wall has a quadrilateral transverse cross-section.

According to an aspect of some embodiments of the present invention, there is provided a method of producing a biodegradable drinking straw as disclosed herein, the method comprising:
i) Discharging said composition through an extrusion die to provide an extrudate;
ii) Substantially immediately following said discharging, cooling said extrudate; and
iii) Cutting said extrudate into a desired length.

According to some embodiments of the method, the cooling process is carried out under subpressure in order to stabilize the structure of the product.

According to some embodiments of the method, extruding is carried out while blowing air, such as at ambient temperature, through a center of said extrusion die.

According to some embodiments of the method, said cooling comprises introducing into a cold water bath, such as in the temperature range of about 20-30° C.

According to some embodiments of the method, between 200 and 800 straws are produced per minute.

According to some embodiments, cutting said extrudate is performed using a blade. According to some embodiments, the method further comprises, following cooling and cutting, forming a bendable region by heating a section of the straw having length of up to about 3 cm to the softening point of the composition and creation of corrugations, for example by clamping the softened straw and forcing into a corrugated template.

According to an aspect of some embodiments of the present invention, there is provided a biodegradable monolayer sheet comprising a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof,
wherein said first biodegradable polymer is present at a concentration of greater than 50% w/w of the total composition and
wherein said first biodegradable polymer is different from said second biodegradable polymer,
said monolayer having a thickness of from about 100 to about 250 microns.

According to some embodiments, the first biodegradable polymer and the second biodegradable polymer together comprise at least 90% w/w of the total composition.

According to some embodiments, the monolayer has a thickness of about 100, about 110, about 120, about 130, about 140, about 150, about 160, about 170, about 180, about 190, about 200, about 210, about 220, about 230, about 240 or about 250 microns.

According to some embodiments of the sheet, said first biodegradable polymer comprises PBAT.

According to some embodiments of the sheet, said second biodegradable polymer comprises PBS.

According to some embodiments of the sheet, said PBAT is present in said composition at a concentration of from 51% to 55% w/w (such as at least 51%, at least 52%, at least 53%, at least 54% or at least 55%) of the total composition and wherein said PBS is present in said composition at a concentration of from about 45% to 49% w/w (such as less than 40%, less than 41%, less than 42%, less than 43%, less than 44% less than 45%, less than 46%, less than 47%, less than 48% or 49%) of the total composition.

According to some embodiments of the sheet, said second biodegradable polymer comprises PLA. According to some such embodiments, said PBAT is present in said composition at a concentration of from 55% to about 70% w/w (such as 55%, 57%, 60%, 65%, 67%, or 70%) of the total composition, and wherein said PLA is present in said composition at a concentration of from about 30% to 45% w/w (such as 30%, 35%, 40% or 45%) of the total composition.

According to some embodiments of the sheet, said first biodegradable polymer comprises PBS.

According to some embodiments of the sheet, said second biodegradable polymer comprises PLA. According to some such embodiments, said PBS is present in said composition at a concentration of from about 75 to about 80% w/w (such as about 75%, about 76%, about 77%, about 78%, about 79% or about 80%) of the total composition, and wherein said PLA is present in said composition at a concentration of from about 20% to about 25% w/w (such as about 20%, about 21%, about 22%, about 23%, about 24% or about 25%) of the total composition.

According to some embodiments of the sheet, said first biodegradable polymer comprises PLA.

According to some embodiments of the sheet, said second biodegradable polymer comprises PCL. According to some such embodiments, said PLA is present in said composition at a concentration of from about 70 to about 85% w/w (such as about 70%, about 71%, about 72%, about 73%, about 74%, about 75%, about 76%, about 77%, about 78%, about 79%, about 80%, about 81%, about 82%, about 83%, about 84% or about 85%) of the total composition and said PCL is present in said composition at a concentration of from about 15% to about 30% w/w (such as about 15%, about 16%, about 17%, about 18%, about 19%, 20%, about 21%, about 22%, about 23%, about 24%, about 25%, about 26%, about 27%, about 28%, about 29% or about 30%) of the total composition.

According to some embodiments of the sheet, said composition further comprises a third biodegradable polymer.

According to some embodiments of the sheet, said third biodegradable polymer comprises PBS. According to some such embodiments, said PLA is present in said composition at a concentration of from about 60 to about 70% w/w (such as about 60%, about 62%, about 64%, about 65%, about 67%, or about 70%) of the total composition, said PCL is present in said composition at a concentration of from about 15% to about 20% w/w (such as about 15%, about 16%, about 17%, about 18%, about 19% or about 20%) of the total composition and said PBS is present in said composition at a concentration of from about 15% to about 20% w/w (such as about 15%, about 16%, about 17%, about 18%, about 19% or about 20%) of the total composition.

According to some embodiments of the sheet, said third biodegradable polymer comprised PBAT. According to some such embodiments, said PLA is present in said composition at a concentration of from about 70% to about 85% w/w (such as about 70%, about 72%, about 75%, about 78%, about 80%, about 82%, or about 85%) of the total composition, said PCL is present in said composition at a concentration of from about 10 to about 15% w/w such as about 10%, about 11%, about 12%, about 13%, about 14% or about 15%) of the total composition and said PBAT is present in said composition at a concentration of from about 5 to about 15% w/w (such as about 5%, about 6%, about 7%, about 8%, about 9%, about 10%, about 11%, about 12%, about 13%, about 14% or about 15%) of the total composition.

According to some embodiments of the sheet, said composition further comprises a nucleating agent. Non-limiting examples of suitable nucleating agents include poly-L-lactide (PLLA) homopolymers such as L130 from Cobion-Purac.

According to some embodiments, said composition further comprises at least one selected from the group consisting of an antioxidant, a slip agent, an antiblock, and combinations thereof.

Non-limiting examples of suitable antioxidants include ascorbic acid.

Non-limiting examples of suitable slip agents include erucamide.

Non-limiting examples of antiblock include silica.

According to some embodiments of the sheet, said composition further comprises at least one coloring agent.

According to some embodiments of the sheet, at least a first portion of said monolayer comprises a first coloring agent and at least a second portion of said monolayer comprises a second coloring agent, wherein said second coloring agent provides a different color to that of said first coloring agent.

The biodegradable monolayer sheet as disclosed herein may be used to form any suitable article, including but not limited to utensils for food or drink, such as trays, bowls, plates, cups, packages or containers and the like, wherein such items are home-compostable.

Many modifications and variations are possible in light of the above teachings. It is, therefore, to be understood that within the scope of the appended claims, the invention can be practiced otherwise than as specifically described.

The specific embodiments listed below exemplify aspects of the teachings herein and are not to be construed as limiting.

Throughout this application, various publications, including United States patents, are referenced by author and year and patents by number. The disclosures of these publications and patents and patent applications in their entireties are hereby incorporated by reference into this application in order to more fully describe the state of the art to which this invention pertains.

Citation of any document herein is not intended as an admission that such document is pertinent prior art, or considered material to the patentability of any claim of the present disclosure. Any statement as to content or a date of any document is based on the information available to applicant at the time of filing and does not constitute an admission as to the correctness of such a statement.

### EXAMPLES

In the experimental section below, all percentages are weight percentages.

Materials and Methods

All the embodiments of polymer sheets according to the teachings herein were made using commercially-available raw materials and devices, using one or more standard methods including: polymer resin drying, resin mixing, film extrusion.

Materials

The following polymer resins and raw materials were acquired from commercial sources:
PBAT poly(butylene adipate terphtalate)
PBS poly(butylene succinate)
PLA poly(lactic acid)
PCL poly(epsilon-caprolactone)
Anti-oxidant:
Slip agent
Anti-block
Nucleating agent

Resin Drying

Before use, resins were dried overnight in an air flow Shini SCD-160U-120H dryer desiccator heated to 50° C.

Resin Mixtures

To make the required polymer mixture resins, the appropriate amounts of the dried constituent resins were dry-blended, introduced into the feed of a twin screw compounder and then melt extruded to form a polymer mixture resin. During melt extrusion in the compounder, the temperature zone settings were 170-175-180-185-190° C. Die at 190° C., a screw speed of 350 rpm and pressure 15-25 bar.

The compounded polymer resin was ground into 1-5 mm diameter pellets using strand pelletizer.

Extrusion

Some embodiments of sheets according to the teachings herein were made by extrusion of monolayers to make a desired sheet.

Sheets were made using a extruder using standard settings as known in the art. Typically the mixture was feed into the extruder with the temperature zone settings 120-190° C. The screw speed was set to provide an extruded layer having the desired thickness in the usual way.

### Example 1

| Material | % weight | kg/hour |
|---|---|---|
| PBAT | 53 | 10.6 |
| PBS | 42.5 | 8.5 |
| Anti-oxidant | 1 | 0.2 |
| Slip anti-block | 1 | 0.2 |
| Nucleating agent | 2.5 | 0.5 |

### Example 2

| Material | % weight | kg/hour |
|---|---|---|
| PBAT | 51.5 | 10.3 |
| PBS | 41.5 | 8.3 |
| Anti-oxidant | 1 | 0.2 |
| Slip anti-block | 1 | 0.2 |
| Nucleating agent | 5 | 1 |

### Example 3

| Material | % weight | kg/hour |
|---|---|---|
| PBAT | 60 | 12 |
| PLA | 35.5 | 7.1 |
| Anti-oxidant | 1 | 0.2 |
| Slip anti-block | 1 | 0.2 |
| Nucleating agent | 2.5 | 0.5 |

### Example 4

| Material | % weight | kg/hour |
|---|---|---|
| PBAT | 67.1 | 13.42 |
| PLA | 28.4 | 5.68 |
| Anti-oxidant | 1 | 0.2 |
| Slip anti-block | 1 | 0.2 |
| Nucleating agent | 2.5 | 0.5 |

### Example 5

| Material | % weight | kg/hour |
|---|---|---|
| PBS | 77.5 | 15.5 |
| PLA | 18 | 3.60 |
| Anti-oxidant | 1 | 0.2 |
| Slip anti-block | 1 | 0.2 |
| Nucleating agent | 2.5 | 0.5 |

### Example 6

| Material | % weight | kg/hour |
|---|---|---|
| PLA | 76 | 15.2 |
| PCL | 19 | 3.8 |
| Anti-oxidant | 1 | 0.2 |
| Slip anti-block | 1 | 0.2 |
| Chelating agent | 3 | 0.6 |

### Example 7

| Material | % weight | kg/hour |
|---|---|---|
| PLA | 78 | 15.6 |
| PCL | 18 | 3.6 |
| Anti-oxidant | 1 | 0.2 |
| Slip anti-block | 1 | 0.2 |
| Chelating agent | 2 | 0.4 |

### Example 8

| Material | % weight | kg/hour |
|---|---|---|
| PLA | 62.4 | 12.48 |
| PBS | 18 | 3.6 |
| PCL | 15.6 | 3.12 |
| Anti-oxidant | 1 | 0.2 |
| Slip anti-block | 1 | 0.2 |
| Chelating agent | 2 | 0.4 |

### Example 9

| Material | % weight | kg/hour |
|---|---|---|
| PLA | 80 | 16 |
| PCL | 18 | 3.6 |
| Anti-oxidant | 1 | 0.2 |
| Slip anti-block | 1 | 0.2 |

### Example 10

| Material | % weight | kg/hour |
|---|---|---|
| PLA | 75 | 15 |
| PCL | 13 | 2.6 |
| PBAT | 10 | 2 |
| Anti-oxidant | 1 | 0.2 |
| Slip anti-block | 1 | 0.2 |

The inventions illustratively described herein may suitably be practiced in the absence of any element or elements, limitation or limitations, not specifically disclosed herein. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

Although the above examples have illustrated particular ways of carrying out embodiments of the invention, in practice persons skilled in the art will appreciate alternative ways of carrying out embodiments of the invention, which are not shown explicitly herein. It should be understood that the present disclosure is to be considered as an exemplification of the principles of this invention and is not intended to limit the invention to the embodiments illustrated.

Those skilled in the art will recognize or be able to ascertain using no more than routine experimentation, equivalents of the specific embodiments of the invention described herein. Such equivalents are intended to be encompassed by the following claims.

1-26. (canceled)

27. A biodegradable monolayer sheet comprising a composition comprising a first biodegradable polymer selected from the group consisting of PBAT, PBS; PLA and combinations thereof; and a second biodegradable polymer selected from the group consisting of PBS, PLA, PCL, PBSA, PBAT and combinations thereof,
wherein said first biodegradable polymer is present at a concentration of greater than 50% w/w of the total composition and
wherein said first biodegradable polymer is different from said second biodegradable polymer,
said monolayer having a thickness of from about 100 to about 400 microns.

28. The biodegradable sheet according to claim 27, wherein said first biodegradable polymer comprises PBAT.

29. The biodegradable sheet according to claim 28, wherein said second biodegradable polymer comprises PBS.

30. The biodegradable sheet according to claim 29, wherein said PBAT is present in said composition at a concentration of from 51% to about 55% w/w of the total composition and wherein said PBS is present in said composition at a concentration of from about 45% to 49% w/w of the total composition.

31. The biodegradable sheet according to claim 27, wherein said second biodegradable polymer comprises PLA.

32. The biodegradable sheet according to claim 31, wherein said PBAT is present in said composition at a concentration of from about 55% to about 70% w/w of the total composition, and wherein said PLA is present in said composition at a concentration of from about 30% to about 45% w/w of the total composition.

33. The biodegradable sheet according to claim 27, wherein said first biodegradable polymer comprises PBS.

34. The biodegradable sheet according to claim 33, wherein said second biodegradable polymer comprises PLA.

35. The biodegradable sheet according to claim 34, wherein said PBS is present in said composition at a concentration of from about 75% to about 80% w/w of the total composition, and wherein said PLA is present in said composition at a concentration of from about 20% to about 25% w/w of the total composition.

36. The biodegradable sheet according to claim 27, wherein said first biodegradable polymer comprises PLA.

37. The biodegradable sheet according to claim 36, wherein said second biodegradable polymer comprises PCL.

38. The biodegradable sheet according to claim 37, wherein said PLA is present in said composition at a concentration of from about 70% to about 85% w/w of the total composition and said PCL is present in said composition at a concentration of from about 15% to about 30% w/w of the total composition.

39. The biodegradable sheet according to claim 37, wherein said composition further comprises a third biodegradable polymer.

40. The biodegradable sheet according to claim 39, wherein said third biodegradable polymer comprises PBS.

41. The biodegradable sheet according to claim 40, wherein said PLA is present in said composition at a concentration of from about 60% to about 70% w/w of the total composition, said PCL is present in said composition at a concentration of from about 15% to about 20% w/w of the total composition and said PBS is present in said composition at a concentration of from about 15% to about 20% w/w of the total composition.

42. The biodegradable sheet according to claim 39, wherein said third biodegradable polymer comprised PBAT.

43. The biodegradable sheet according to claim 42, wherein said PLA is present in said composition at a concentration of from about 70% to about 85% w/w of the total composition, said PCL is present in said composition at a concentration of from about 10% to about 15% w/w of the total composition and said PBAT is present in said composition at a concentration of from about 5% to about 15% w/w of the total composition.

44. (canceled)

45. The biodegradable sheet according to claim 27, wherein said composition further comprises at least one selected from the group consisting of an antioxidant, a slip agent, an antiblock, a nucleating agent and combinations thereof.

46. The biodegradable sheet according to claim 27, wherein at least a portion of said composition further comprises a coloring agent.

47. A drinking straw comprising an elongated wall enclosing a lumen, wherein said wall comprises the biodegradable sheet of claim 27.
